(19) United States
(12) Patent Application Publication
(10) Pub. No.: US 2012/0227600 A1
(43) Pub. Date: Sep. 13, 2012

(54) ADJUSTABLE PRESS CHASE

(76) Inventor: Charles William Hawley, Conyers, GA (US)

(21) Appl. No.: 13/418,327

(22) Filed: Mar. 12, 2012

Related U.S. Application Data
(60) Provisional application No. 61/452,065, filed on Mar. 11, 2011.

(51) Int. Cl. B41B 1/18

(52) U.S. Cl. 101/393

(57) ABSTRACT

An apparatus and methods for the adjustment and positioning of a slider bars (and in turn, tools, dies, etc.) in a chase for use in a press are disclosed. The apparatus and methods provide for the adjustment of slider bars within a chase. The slider bars are slidably secured in one or more channels in a guide portion of a chase to permit movement and adjustment of the slider bars (and in turn, tools, dies, etc.) in the horizontal and the vertical axis.

### CROSS-REFERENCE TO RELATED APPLICATIONS

This application claims priority from co-pending U.S. Provisional Application Ser. No. 61/452,065 filed Mar. 11, 2011, which is titled “ADJUSTABLE PRESS CHASE”, which is hereby incorporated by reference.

### FIELD OF THE INVENTION

This invention relates to press chases and, more particularly, to the adjustment of slider bars and dies within a chase portion of a press.

### BACKGROUND OF THE INVENTION

The modern automatic platen press has not substantially changed since the introduction of this type of press in the early 1800's. Basically, a platen press positions a substrate or print media, or other media, such as paper, on a platen and brings the substrate into contact with a die or form to an image on the media or otherwise alter a media. In operation, a number of additional steps are also involved. Initially, the dies or forms for printing (or other purposes) are set in a form which is secured to a back-plate to properly position the characters or images for printing, as well as dies for perforating, scoring, embossing, debossing, etc. Ink is applied to the raised surface of dies or forms. These raised surfaces define the characters or image to be printed. Finally, the print media (or other media) is placed on the platen, precisely aligned and brought into contact with the form or die containing the characters or image by movement of the of the platen toward the back-plate. As the print media is pressed between the platen and the raised surfaces of the dies or forms, the image or characters is transferred to the print media (similarly, affecting the paper, or other media, for various other treatments (depending on the desired effect on the media) for perforating, scoring, embossing, debossing, etc.). The particular mechanisms to carry out the printing process may vary from press to press but the main components of the modern platen press are generally similar or analogous. Although, in theory, the process is relatively simple, the particular components required to carry out this process are relatively complex.

As mentioned above, the dies or forms dies containing the images or letters for printing are initially set in a chase or form which is secured to a back-plate to properly position the characters or images for printing (as well as dies for perforating, scoring, embossing, debossing, etc.). As with the overall character of the press, the methods for the precise positioning dies and forms has also remained substantially unchanged. The dies are typically fitted within a chase or frame that is mounted to a back plate of a press. The die is then positioned at approximate the desired position. Furniture and coins are finally positioned around the die to bias the die within the chase. Once biased within the chase, the chase is fitted within the press and one or more sample are printed (or otherwise effected) to gauge whether or not the die is in the proper position. If the die is properly positioned, the subject job is commenced. If the die is not properly positioned, the chase must be removed and the die repositioned within the chase by the addition of furniture and/or the adjustment of the coins. The insertion and removal of the chase can be slow and labor intensive. Therefore, a need exists for an apparatus and methods that enable adjustment of the position of the die within the chase without requiring removal of the chase from the press. Furthermore, the positioning of the die using furniture and coins can be cumbersome and typically requires skilled labor. Therefore, a need exists for an apparatus and methods that simplify the process of adjusting the position of the die within the chase. In addition, the positioning of the die using furniture and coins is inherently slow. Therefore, a need exists for an apparatus and methods that reduce the time required for positioning dies within a chase for printing or otherwise effecting the media.

### SUMMARY OF THE INVENTION

The present invention is directed to a chase system for use with a printing press, the chase system comprising a chase having a horizontal axis x and a vertical axis y, the chase having a lower horizontal guide which is parallel with the x axis, an upper horizontal guide which is parallel with the x axis, a left vertical guide which is parallel with the y axis, and a right vertical guide which is parallel with the y axis, wherein at least one of the lower horizontal guide, the upper horizontal guide, the left vertical guide and the right vertical guide contains at least one channel therein which is parallel to the respective axis of the respective guide.

### BRIEF DESCRIPTION OF THE FIGURES

FIG. 1 illustrates a perspective view of an exemplary embodiment of the present invention including an exploded perspective view of an exemplary slider bar portion and tool;

FIG. 2A illustrates a cross sectional view along line A-A of the exemplary embodiment of FIG. 1 including an exemplary slider bar;

FIG. 2B illustrates a cross sectional view along line A-A of the exemplary embodiment of FIG. 1 including another exemplary slider bar;

FIG. 3 illustrates a cross-sectional perspective view of a portion of the exemplary embodiment of FIG. 1 showing a relationship between exemplary guides, a slider bar and a mount;

FIG. 4 illustrates a top view of a corner portion of an exemplary chase showing two guides;

FIG. 5A illustrates a perspective view of an exemplary slider bar of an exemplary embodiment of the present invention;

FIG. 5B illustrates a top view of the exemplary slider bar of FIG. 5A;

FIG. 6 illustrates a perspective view of a guide of an exemplary embodiment of the present invention;

FIG. 7 illustrates a cross-sectional perspective view of a location registering portion of an exemplary embodiment of the present invention; and

FIG. 8 illustrates a cross-sectional perspective view of another location registering portion of an exemplary embodiment of the present invention.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

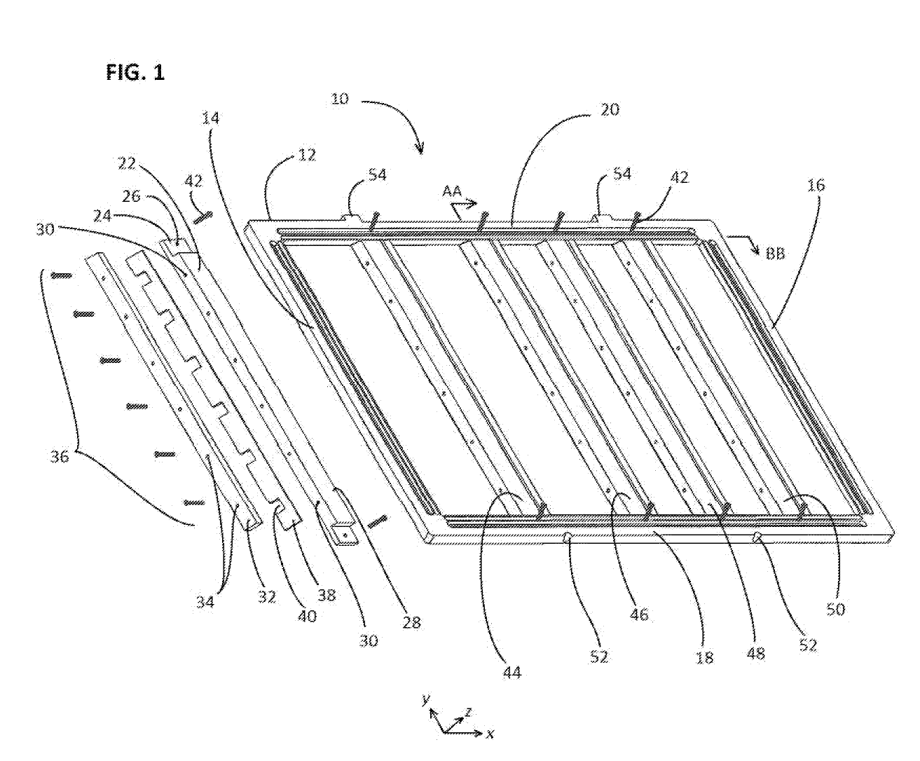

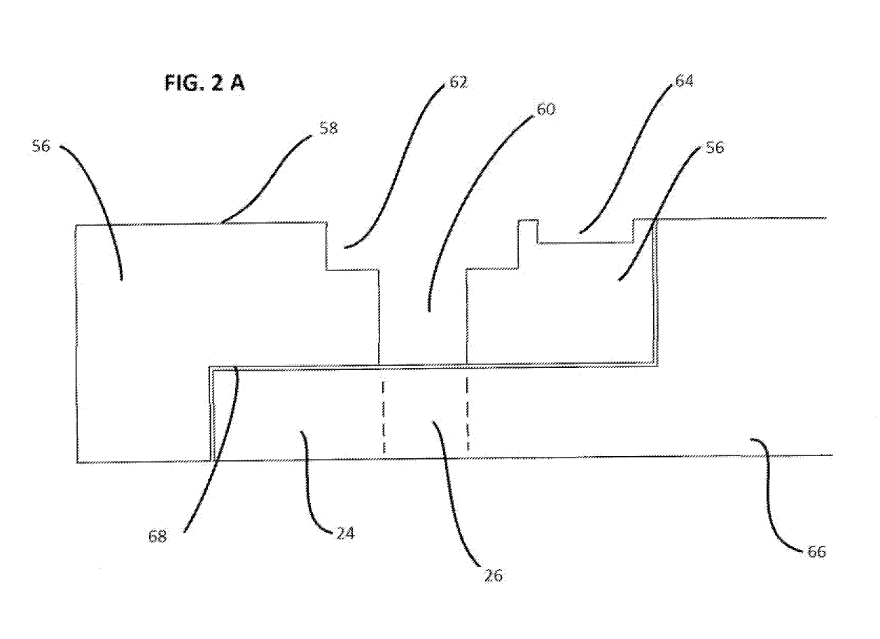

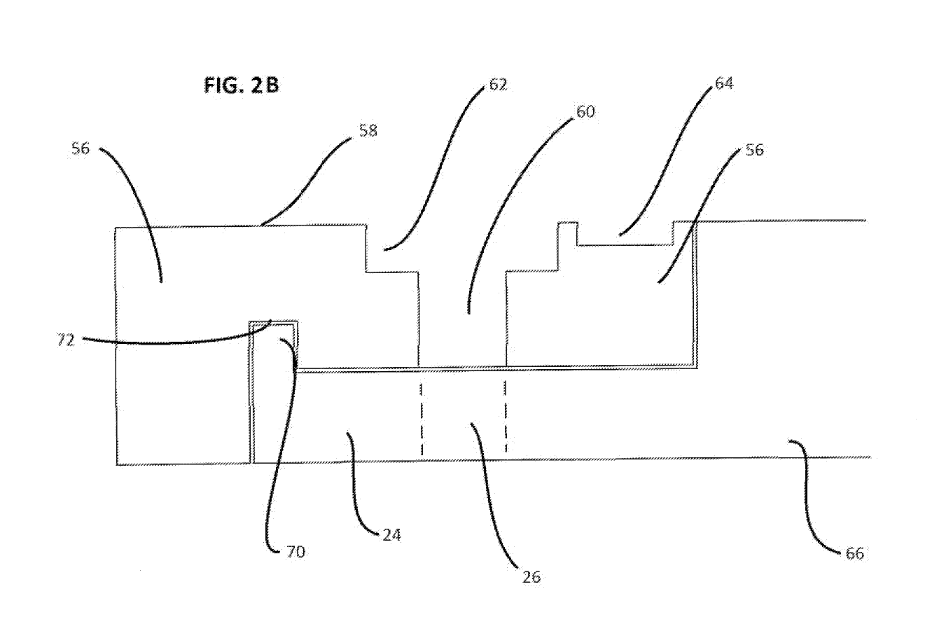

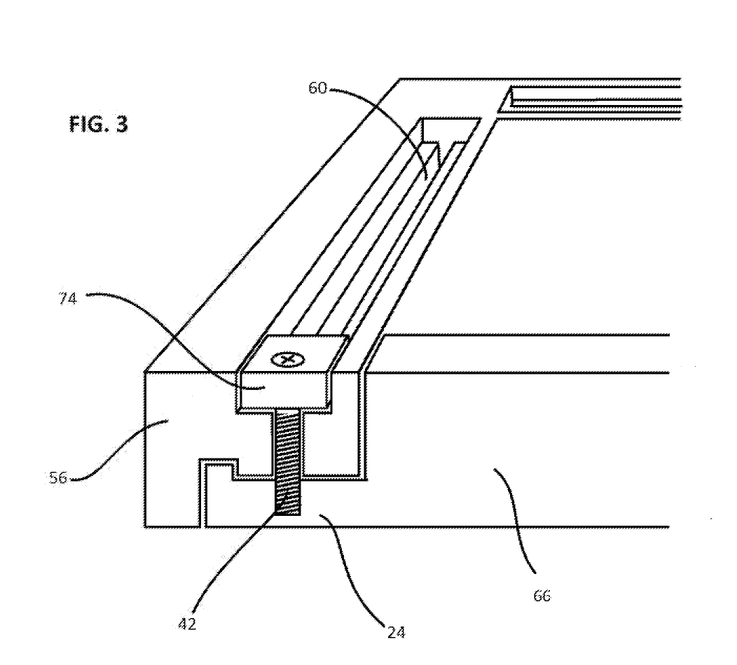

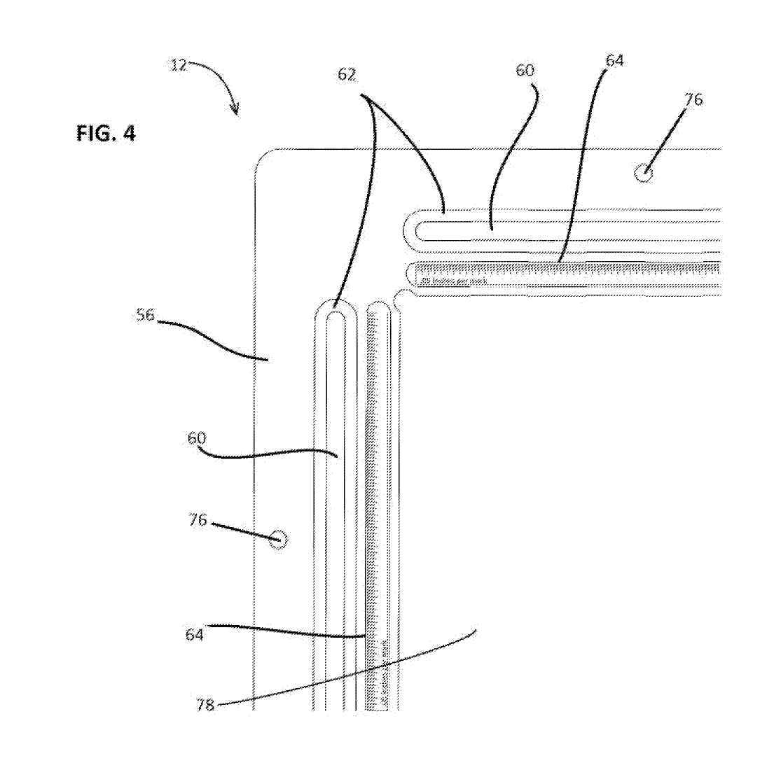

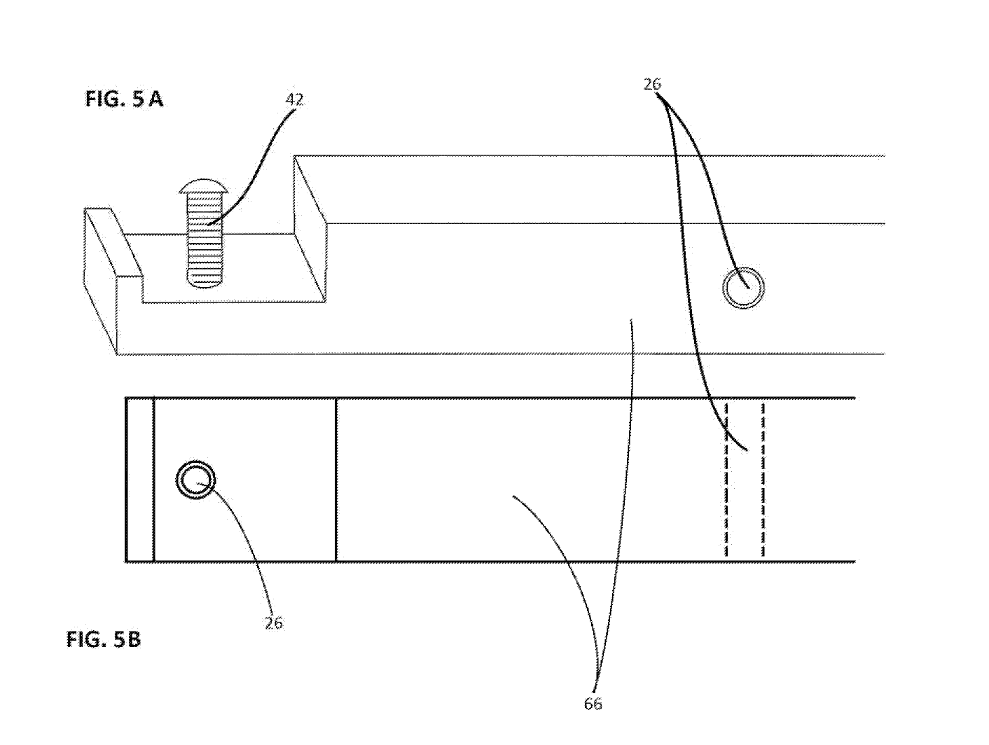

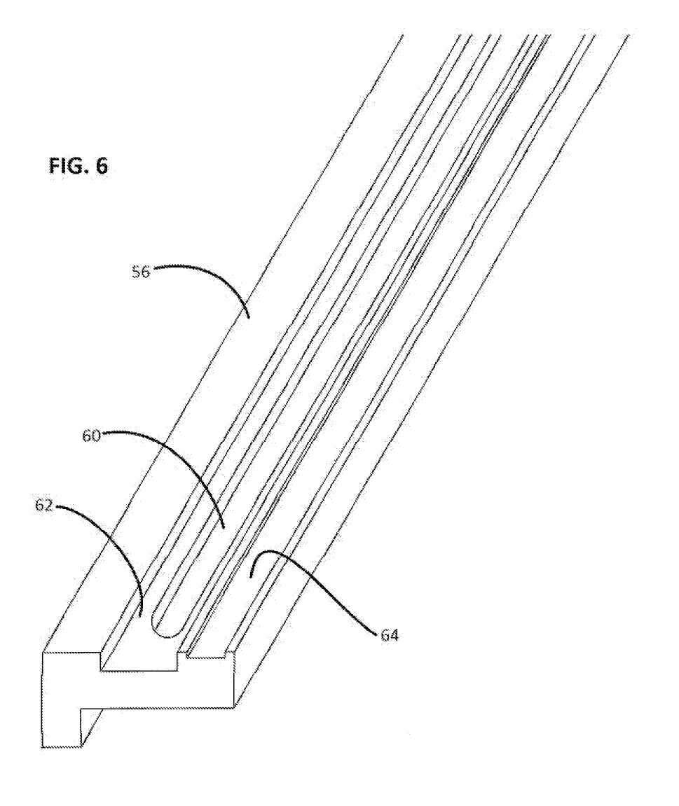

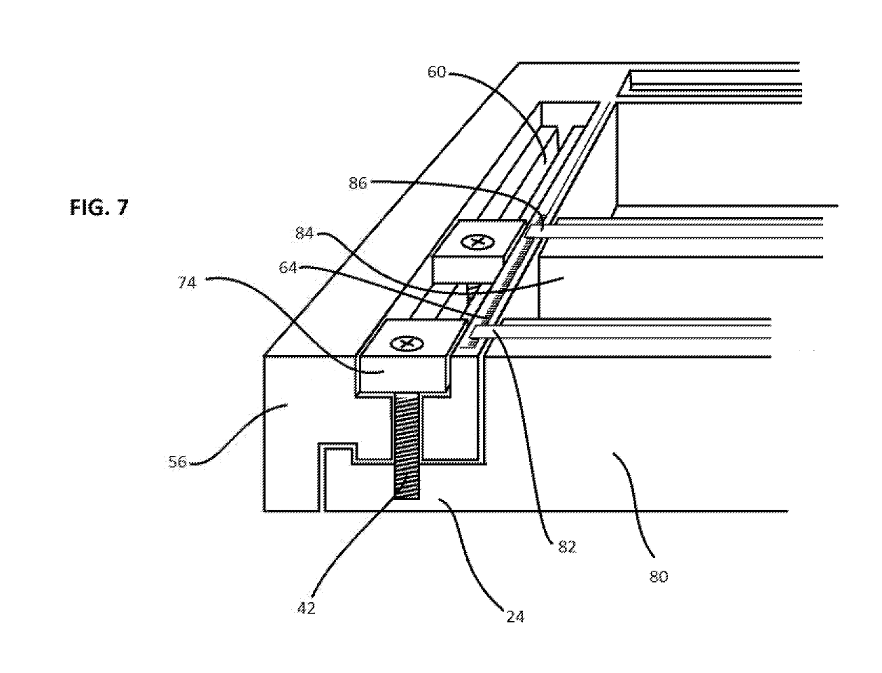

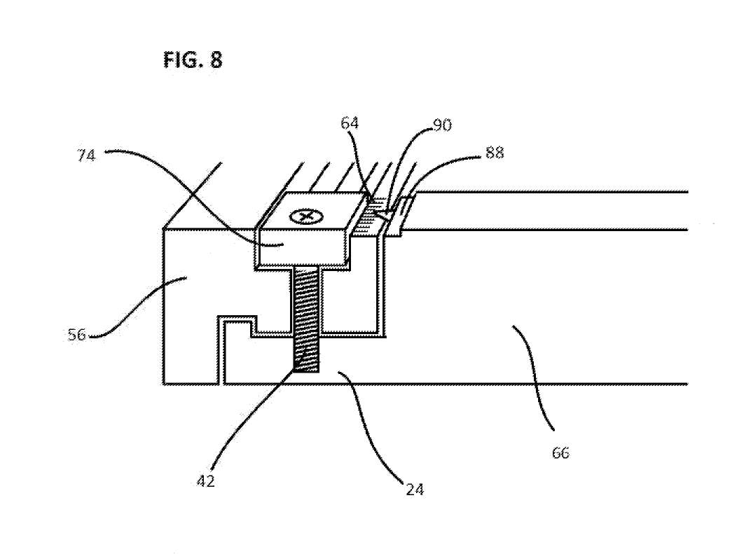

FIG. 1 illustrates a perspective view of an exemplary embodiment of the present invention including an exploded perspective view of an exemplary slider bar portion and tool. FIG. 2A illustrates a cross sectional view along line A-A of the exemplary embodiment of FIG. 1 including an exemplary slider bar. FIG. 2B illustrates a cross sectional view along line A-A of the exemplary embodiment of FIG. 1 including another exemplary slider bar. FIG. 3 illustrates a cross-sectional perspective view of a portion of the exemplary embodiment of FIG. 1 showing a relationship between exemplary guides, a slider bar and a mount. FIG. 4 illustrates a top view of a corner portion of an exemplary chase showing two guides. FIG. 5A illustrates a perspective view of an exemplary slider bar of an exemplary embodiment of the present invention. FIG. 5B illustrates a top view of the exemplary slider bar of FIG. 5A. FIG. 6 illustrates a perspective view of a guide of an exemplary embodiment of the present invention. FIG. 7 illustrates a cross-sectional perspective view of a location registering portion of an exemplary embodiment of the present invention. FIG. 8 illustrates a cross-sectional perspective view of another location registering portion of an exemplary embodiment of the present invention.

The present invention meets the above described needs and provides additional improvements and advantages that will be recognized by those skilled in the art upon review of the present disclosure. In a preferred form the present invention provides an apparatus and methods for adjusting the position of a die within a chase.

FIG. 1 illustrates an exemplary chase system 10 having a chase 12, horizontal axis x, vertical axis y, left vertical guide 14, right vertical guide 16, lower horizontal guide 18, and upper horizontal guide 20. As further illustrated in the following figures, each of guides 14, 16, 18, 20 may have a channel therein to allow positioning and securing of one or more slider bars 22, 44, 46, 48, 50 therein. Also illustrated in FIG. 1 is an exemplary slider bar 22 having a flange 24 which has a lower profile (i.e., height in the z axis) as compared to the body of bar 22 which may have a somewhat taller profile such as illustrated by portion 28. For this exemplary slider bar, a front plate 32 may be attached to slider bar 22's body bolts/screws 36 which may be inserted into/through slots/holes 34 in front plate 32 and received into slots/holes 30 in slider bar 22.

For this exemplary slider bar, various tools may be received by/held in place between face plate 32 and slider bar 22 such as exemplary tool 38 (illustrated as a cutting blade, although other tools include, but are not limited to, scores, and perfs), For this exemplary tool 38, a series of notches 40 are found on the tool which allow for positioning about the several bolts/screws 38. Other means may also be used for fitting the tools into the various members of bar 22 including, but not limited to, holes, notches, and slots.

Although numerous methods may be utilized to fix (albeit releasedly so) bars 22, 44, 46, 48, 50 to chase 12 including but not limited to screws/bolts 42 (which may also be referred to as an alignment screw, alignment bolt, lock screw, etc.) which may be threading received into holes 26 in the flange 24 of the respective bar. Other suitable methods may be utilized to secure the bars to the various guides, including, but not limited to, clamps, bolts, and other releasable fittings.

Multiple additional features may be incorporated into a specific chase, or adapted for a specific installation including but not limited to, mounting slots 52 and mounting notches 54.

FIG. 2A illustrates a cross-sectional view through section line AA of FIG. 1. Illustrated is an exemplary guide 56 (which may be illustrative of exemplary guides 14, 16, 18, 20 from FIG. 1) and a portion of an exemplary bar 66 (which could be any of sidebars 22, 44, 46, 48, 50, for example). In this embodiment, flange 24 is received into recess/slot 68 in guide 56. (Note that any suitable gap may be present between the various members to allow sufficient space for alignment and positioning of the various members, but not so much space as to allow them to shift when locked into position.) Top surface 58 of guide 56 is also illustrated as well as channel 60, countersink 62, and a space for various indicia 64 (i.e., which may indicate the positioning of the various slider bars, etc. in inches, or any other measurement). Note that it may be advantageous to have the surface of such indicia at the same level as top surface 58, or countersunk below such surface as indicated. Top surface 58 is also the uppermost surface of chase 10. Hole/slot 26 in exemplary bar 66 is also shown.

FIG. 2B illustrates a cross-sectional view through section line AA of FIG. 1. Illustrated is an exemplary guide 56 (which may be illustrative of exemplary guides 14, 16, 18, 20 from FIG. 1) and a portion of an exemplary bar 66 (which could be any of sidebars 22, 44, 46, 48, 50, for example). In this embodiment, flange 24 is received into recess/slot 68 in guide 56.

FIG. 3 illustrates another exemplary relationship between an exemplary guide 56 and a bar 66. In this arrangement a mount 74 may be utilized to help secure bar 66 to guide 56 such that screw or bolt 42 may be accessed from above for easy adjustment, yet extend through mount 74 such that a bar 66 may be tightened into a secure configuration with guide 56. In some embodiments, mount 74 may be a washer of any suitable configuration including, but not limited to, round elliptical, square, rectangular, parallelepiped, spherical, and cubic. In other embodiments, mount 74 may be incorporated into another element or component such as may be accomplished with a wide headed bolt, screw, or other means. In yet other embodiments, there may be no mount present. In some embodiments the top surface of mount 74 (and screw/bolt 42) is co planar, or slightly below, the top surface of guide 56. When screw/bolt 42 is loosened (or removed entirely), the combination of bar 66, bolt 42, and spacer 74 may be slid along channel 60 to a desired location (i.e., registered with indicia 64 until the desired alignment is achieved), then screw/bolt 42 may be tightened to prevent undesired movement of bar 66. Various means may be utilized as a constraint to limit such movement of a slide bar. Such constraint may be of any suitable means including, but not limited to that described above, screws, bolts, clamps, etc. or combinations thereof. Further, while some embodiments may have a washer or other mount, other embodiments may not.

FIG. 4 illustrates a top view of a portion of chase 12 showing a relationship between guides 56, channels 60, countersinks 62, indicia 64, and mounting holes 76. Any number of mounting holes 76 (including zero) may be utilized for mounting of the chase for use in a printing process.

In some embodiments, the tool may extend over the top surface of the indicia such that it may enable registering of the tool(s) for positioning/placement. In other embodiments any number (and mechanism) of indicator may be used in addition, or incorporated with any element of the slider bar combination (i.e., slider bar, screw/bolt, and mount) which may tie in to the indicia to indicate the current placement of the slider bar. FIGS. 7-8 illustrates various such methods. Working area 78 is an area between guides 14, 16, 18, 20 in which dies and other tools/materials may be secured for the desired printing job/process.

FIGS. 5A-B illustrate partial perspective and top views, respectively, of an exemplary slider bar 66. Illustrated is an exemplary relationship between bolt/screw 42, hole/slot 26 and various surfaces of slider bar 66.

FIG. 6 illustrates an exemplary cross-sectional view along lines

BB of FIG. 1. Guide 56 may have one or more channels 60 which may be countersunk into the top surface of guide 56 as illustrated by countersink 62. Also shown is a location for indicia 64.

FIG. 7 illustrates an exemplary embodiment in which the tool extends beyond the length of the upper portion of the bar in order to indicate its position on the indicia. In this embodiment, first slider bar 80 has an associated tool 82 affixed thereto such that tool 82 overhangs indicia 64 in order to register the position of the tool. Similarly, a second slider bar 84 has an associated tool 86 which overhangs indicia 64 in order to register the position of tool 86.

FIG. 8 illustrates an exemplary embodiment in which an arrow shaped indicator 90 is incorporated into the slider bar (it could similarly be incorporated into mount 74) to indicate the position of the tool. In such an embodiment, it may be desirous to have even the uppermost surfaces of such indicator (i.e., arrow 90) be at least some minimum distance below the uppermost surfaces of the tools so as not to inadvertently affect the print job. In this embodiment, slider bar 66 has a lowered section 88 (to which indicator 90 may be affixed, or incorporated, or unitary therewith) which is lower than the uppermost surfaces of guide 56, mount 74, and some portions of bar 66. Note that such a lowered section of bar 66 is not mandatory, but may be advantageous in certain applications of the chase. In some embodiments with an indicator 90, the indicator should be placed or constructed in such a way that it does not impair or impede the placement of the slide bar from an underside of the chase/guide. In some examples, such as that illustrated in FIG. 8, indicator 90 may be comprised of a flexible material such that it may be deflected out of the way so that the slide bar may be placed into the chase without the indicator preventing such placement. In other embodiments, such indicator may be spring loaded/biased so that the slide bar is not impeded from being placed into the chase. In some embodiments the indicator may be incorporated with, or connected to the mount which may be advantageous as the mount is accessible/placeable from an upper surface of the chase, and thus be installed/applied/placed after the slide bar has been inserted into the chase.

The various slider bar(s) (and tools/dies, etc.) are removably attachable to the chase/guides. The slider bars (and associated tools/dies/etc.) may be securely, though removably, attached by way of screws, bolts, clamps, etc. In some embodiments, the slider bar is received on the underside of the chase frame/guide (i.e., receive into a recessed portion as illustrated in various of the attached FIGs.) such that the chase (and it's associated guides and other structures) hold the slider bars from rising (i.e., in the z-direction) while allowing them to be adjusted along the channel/guide.

However, note that although received on the underside of the chase/guides, the slider bars may be secured into a specific/given position from the top side of the chase guides such as illustrated in various figures through the use of screws, bolts or other means. Thus, even when the chase is placed on the printing press, the user may adjust the slider bars (and associated tools, dies, etc.) from above without need to adjust the chase itself. In some embodiments, the slider bar(s) may be affixed at one end, while in other embodiments, the slider bar is affixed to two respective guides (channels) at each end of the slider bar.

In some embodiments, there may be a length or measurement indicator (referred to herein as indicia) on one or more surfaces (or recessed surfaces) of the chase.

Various embodiments of the present invention may be utilized in any number and configuration of presses. Each of the components may be unitary or comprised of multiple members, i.e., the frame, chase, guide, and slider bar(s) may be one or more pieces.

Though some embodiments may be generally rectangular, the various components of any given chase, guide, slider bar, etc. may be of any suitable shape. The chase may be locked into a press temporarily or permanently. In some embodiments, the frame may be locked into the press through use of existing die board locking mechanisms.

The interior of the chase (defined herein as working area) is open to accept a wide range of slider bars, tools, and dies that may be used to score, perforate, cut, or otherwise impact the media to be treated. Further, honeycomb plates to cold stamp, heat stamp, hot stamp, foil stamp, emboss, and deboss may also be utilized with the herein described chase system and this may be simultaneous with other activities including, but not limited to, scoring, cutting, and perforating. All slider bars, tools, dies, and other accessories and hardware may be replaceable and sized to fit any sized chases.

The slider bars may include channels, front plates, and back plates which may accommodate and retain cutting blades, perforating blades, scoring blades, and other tools in an upright position such that they can be tightened and reused until the blades (or other article) are no longer useful/acceptable. Special dies or other members may be configured into shapes and inserted into the guides as well.

In some embodiments, the width of the slider bar, i.e., that edge that will be in contact, or in close proximity, with the guide, frame or chase, may be sufficiently long such that it is in a square/orthogonal relationship with the guide/frame/chase. If the length is too short, it may be extremely difficult to obtain (or maintain) orthogonality. In some embodiments, the width is approximately 0.5 inches. In some embodiments, this width is 0.5 inches or more. In some embodiments, this width is 0.75 inches or more. In some embodiments, this width is 1 inch or more. In some embodiments, this width is 1.25 inches or more. In some embodiments, this width is 1.5 inches or more. The length of the slider bar can be of any suitable length and will depend on the size of the press for which the chase is to be used. Similarly, the thickness (i.e., z-axis measurement) will be predetermined based on the requirements of the particular press the device will be used with.

Although various components of the present invention may be illustrated as being of a particular shape/size/thickness for convenience, such components may be of any suitable shape, size, thickness, configuration, orientation, etc. Further, the height, width, depth, thickness, etc. of the device and its' various components may be of any suitable dimension and any reference to distances in the figures is only for convenience or of an exemplary embodiment.

The various members may be attached to the main chase/frame/body/guide or any other part or portion thereof by any suitable means including, but not limited to, screwing, bolting, clamping, bonding, welding, fasteners, buckles, pins, screws, bolts, quick release buckles, and buttons.

The various components of the present invention may be comprised of any suitable materials including, but not limited to, rubber, plastic, wood, metal, aluminum, plastic, ceramic, glass, carbon fiber, steel, and metal alloys.

Note that although the terms horizontal and vertical axes may be used herein, the present invention may be used in any planar system, i.e., as long as there is a first axis and a second axis orthogonal to the first. Thus, it is not required that either axis be horizontal or vertical.

While the specification has been described in detail with respect to specific embodiments thereof, it will be appreciated that those skilled in the art, upon attaining an understanding of the foregoing, may readily conceive of alterations to, variations of, and equivalents to these embodiments.

What is claimed is:

1. A chase system for use with a printing press, said chase system comprising:
a chase having a horizontal axis x and a vertical axis y, said chase having
a lower horizontal guide which is parallel with said x axis,
an upper horizontal guide which is parallel with said x axis,
a left vertical guide which is parallel with said y axis,
and a right vertical guide which is parallel with said y axis,
wherein at least one of said lower horizontal guide, said upper horizontal guide, said left vertical guide and said right vertical guide contains at least one channel therein which is parallel to the respective axis of said respective guide.

2. The chase system of claim 1, wherein said at least one channel is countersunk below an uppermost surface of said chase.

3. The chase system of claim 1, wherein both said lower horizontal guide and said upper horizontal guide have at least one channel therein.

4. The chase system of claim 1, wherein each of said lower horizontal guide, said upper horizontal guide, said left vertical guide and said right vertical guide has at least one channel therein.

5. The chase of claim 4, wherein each of said channels is countersunk below the uppermost surface of said chase.

6. The chase system of claim 1, further comprising at least one slide bar, said side bar having a body and at least one flange at one end of said body
wherein said flange has a smaller profile in a z axis as compared to a profile of said body of said slide bar and wherein the z axis is orthogonal to both said x axis and said y axis of said chase and an upper surface of said flange is in contact with one of said guides and said slide bar extends between either said upper horizontal guide and said lower horizontal guide or between said left vertical guide and said right vertical guide.

7. The chase system of claim 6, wherein said slide bar is constrained to move either in the x axis of said chase or the y axis of said chase.

8. The chase system of claim 7, further comprising a constraint which is adjustable from above said chase such that when said constraint is released, said slide bar is capable of sliding, but when said constraint is locked, said slide bar is prevented from moving.

9. The chase system of claim 8, wherein said constraint includes a screw which is accessible from above said chase and extends through said channel and is received into said flange of said slide bar.

10. The chase system of claim 9, wherein said constraint further comprises a washer which is in contact with said channel.

11. The chase system of claim 10, wherein said slide bar has a plurality of holes therein for receiving screws wherein said screws may hold a tool for use in a printing process.

12. The chase system of claim 10, further comprising a face plate which may be removedly attached to said slide bar wherein a tool may be securedly mounted between said face plate and said slide bar.

13. The chase system of claim 12, further comprising a printing press wherein said chase is placed on said press such that a surface of said printing press coupled with at least one of said guides prevents said slide bar from moving in said z-axis and said constraint prevents said slide bar from moving in said x and y axes when said constraint is locked.

14. The chase system of claim 1, further comprising at least one slide bar, said side bar having a body and a flange at each end of said body
wherein said flanges have a smaller profile in a z axis wherein the z axis is orthogonal to both said x axis and said y axis and said slide bar extends between either said upper horizontal guide and said lower horizontal guide or between said left vertical guide and said right vertical guide.

15. The chase system of claim 13, wherein each of said flanges is in contact with a bottom surface its respective guide such that said flange is constrained from moving in the z axis by said guide and wherein when said chase and said slide bar are positioned on a printing press, said printing press and said chase cooperate to prevent said slide bar from moving in said z axis.
